(19) United States
(12) Patent Application Publication
(10) Pub. No.: US 2006/0123087 A1
(43) Pub. Date: Jun. 8, 2006

(54) Email storage format including partially ordered logs of updates to email message attributes

(76) Inventor: David W. Gibson, Aranda (AU)

Correspondence Address: LAW OFFICES OF MICHAEL DRYJA, 704 228TH AVENUE NE, PMB 694, SAMMAMISH, WA, 98074, US

(21) Appl. No.: 11/004,282

(22) Filed: Dec. 4, 2004

(51) Int. Cl. G06F 15/16

(52) U.S. Cl. 709/206

(57) ABSTRACT

Email messages are stored without organization; the email messages are not stored in folders, and are otherwise not organized for storage purposes. The messages each have attributes, such as the folder in which they are to be displayed. The messages are organized, such as in folders, just for display purposes—the messages themselves are not moved; only attributes of the messages change. The messages are indexed by their contents. Metadata regarding the messages are stored as partially ordered logs of updates to the messages' attributes. The metadata may be stored as metadata events, where an event describes a change to an attribute of a message. A log of the events is partially ordered in that the events are organized in the order in which they occur as to a specific copy of the messages, but not necessarily in the order in which they occur as to all copies.

### FIELD OF THE INVENTION

The present invention relates generally to the storage of electronic mail (“email”) messages, and more particularly to such storage in which updates to attributes of the email messages are stored as partially ordered logs.

### BACKGROUND OF THE INVENTION

Electronic mail, or email, has proven to be one of the most popular applications for networked computers, like those interconnected via the Internet. An individual with an email address is able to send email messages to any other individual who also has an email address. With the growing popularity of email, computer users now want and expect to retrieve their email messages everywhere. They may have computers at home, computers at work, portable computers for when they travel, as well as cell phone and other types of devices that are all able to access email messages.

However, the original email storage model portended email messages being stored on a central server until downloaded to a client device like a desktop or laptop computer or a cell phone. This means that when a user accesses his or her email messages on one computer, he or she may not be able to review the email messages downloaded to that computer when working on another computer. That is, the original email storage model, used in conjunction with the POP3 protocol, does not accommodate email access on multiple client devices very well.

A more recent email storage model retains all email messages on a central server, and allows individual client devices to store locally cached copies of the messages: For instance, this email storage model can be used in conjunction with some modes of operation of the IMAP4 protocol. However, if email messages on the central server are manipulated online and their locally cached copies are manipulated offline, synchronization can be difficult to accomplish. For instance, data loss can result because a given email message is deleted from the server, but the locally cached copy of this email message is moved from one folder to another folder on a client device while the client device is offline from the server.

Synchronization of email messages, in other words, has proven to be a problem when email messages are accessed using different client devices. A user may access email at a first computer, organizing the email messages in various folders, and then may access the email at a second computer, organizing the same email messages in other folders. If there is not a way to synchronize the email messages stored on each computer, as well as those stored on the central server that initially receives the email messages, then at best the organization desired by the user may not be able to be achieved, and at worst email messages may be lost.

One approach to synchronizing data generally is employed by the Bayou project undertaken by the XEROX Palo Alto Research Center (PARC), and the Ficus distributed file system that is used in some versions of the UNIX operating system. This approach is to assign each replica, or copy, of data that may be later synchronized with a unique identifier. Changes to the data are then individually assigned with a unique identifier that includes the unique identifier of the replica of data. As such, synchronization is made easier, because the changes are able to be ordered and the sources of the changes determined.

In the context of email synchronization, this approach means that each device that stores email messages is assigned a unique identifier. For example, each computer that a user uses to access and store email messages is assigned a unique identifier, as well as the central server that initially receives the email messages. However, using this approach to provide for email synchronization can result in a decreased robustness in certain situations. First, if a store of email messages is copied to a device and subsequently modified without using a special replication algorithm specified by this approach for synchronizing data, email messages can be lost or corrupted. This is because copying the store in this way will not cause a new unique identifier to be properly created, and so the synchronization methods that assume this will fail.

Second, if a device that even has its own unique identifier crashes, such that its copy of the email messages is lost, restoring the device with an older, backup copy of the email messages that predate the last synchronization can cause synchronization problems. For instance, email messages may be duplicated, and other email messages may be lost. This is because the older, backup copy of the email messages will have the same supposedly unique identifier as the newer copy that crashed, such that later synchronization will presume a starting point of the newer copy of email messages, when in fact the working current copy is the older, backup copy of email messages. In sum, the prior art approaches to synchronizing data described here are insufficiently robust in the context of email messages, where users, as opposed to network administrators, will likely be initiating and be responsible for synchronization.

For these and other reasons, therefore, there is a need for the present invention.

### SUMMARY OF THE INVENTION

The present invention relates to an email storage format that includes partially ordered logs of updates to email message attributes. A method of the invention stores email messages without organization, in that the email messages are not stored in folders, and otherwise need not be purposefully organized for storage purposes. The email messages each have a number of attributes, such as the folder in which they are to be displayed. That is, the email messages are organized, such as in folders, only for display purposes, and not by moving the messages themselves, but rather by changing attributes of the messages. Each message is, however, assigned an at least substantially unique label. The method then indexes the email messages. The method also stores metadata regarding the email messages as one or more partially ordered logs of updates to the attributes of the email messages.

For instance, the metadata may be stored as metadata events regarding each email message, where a metadata event describes a change to one of the attributes of the email message. A change may be that the email message is indicated as having been deleted (although the email message may not be actually removed), that the email message has been read, or that the email message should be displayed in a given folder (although the email message itself is not stored in that folder). In one embodiment, there may thus be no notion of actually deleting an email message completely, but rather just deleting the email message from a particular folder.

There can in different embodiments be a partially ordered log of these metadata events as to each email message, and/or a global partially ordered log of the metadata events that is not organized by email message. Each metadata event has an at least substantially unique identifier, the uniqueness of which does not necessarily depend on having a unique identifier for the computer system on which the metadata event has been generated. The identifier is at least substantially unique to largely prevent the same identifier being assigned to different metadata events on different computer systems—that is, to prevent identifier “collisions.” In general, once an email message has been received, it is never altered or deleted. Rather, only attributes of the message are changed, by adding metadata events describing such changes.

The log of the metadata events is partially ordered in that it records the order in which the events occur as to a specific copy of the email messages, but not necessarily the order in which they occur as to all existing copies of the email messages. For example, one copy of the email messages may be stored on a first computer, and another copy may be stored on a second computer. Metadata events generated as to the copy on the first computer are ordered as to themselves, but not necessarily as to metadata events generated as to the copy on the second computer, even after synchronization between the computers occurs. The ordering of the log is not necessarily a physical ordering of the events in one embodiment of the invention in that where and how the events are physically stored within a computer system may not mirror the ordering of the log.

Synchronizing a first copy of the email messages stored on a first computer with a second copy of the email messages stored on a second computer can proceed as follows with respect to the first computer. The first computer receives the second copy of the email messages from the second computer. Because none of the email messages of either copy are organized in particular folders, the first computer simply compares which email messages are present in the received second copy but not in its first copy, adds these email messages to its first copy, and indexes them. In one embodiment, the first computer just receives the unique labels of the messages in the second copy, and then requests from the second computer those messages that are not in the first copy, based on these unique labels.

Synchronization also involves synchronizing the metadata regarding the email messages. The first computer that has been described in the previous paragraph stores a first copy of metadata events, and receives a second, copy of metadata events from the second computer. The events received from the second computer are received in the partial order in which they are stored at the second computer, such that no metadata event that has not yet been received may precede the events that have been received, but the event currently being received may and likely will precede the events that have not yet been received. The first computer compares which metadata events are present in the second copy received but not in its first copy, adds these events to its first copy, and applies them. In one embodiment, the first computer just receives the unique identifiers of the metadata events in the second copy, and then requests from the second computer those events that are not in the first copy, based on these unique identifiers.

A computing system of the invention includes one or more processors, a storage, and a computer program. The storage stores a number of email messages, an index of the email messages, and metadata events regarding the email messages. The email messages have a number of attributes, such as one or more display purposes-only folder attributes in which the email messages are to be displayed. The index of the email messages is generated from the contents of the messages, such as from either the bodies and/or the headers of the email messages in one embodiment. The metadata events are organized as one or more partially ordered logs of updates to the attributes of the email messages. Each event describes a change to an attribute of a corresponding email message, and has an at least substantially unique identifier whose uniqueness does not depend on a having a unique identifier for the computing system itself. The computer program is executed by the processors, where the program generates and maintains the index, and synchronizes the email messages and the metadata events with email messages and metadata events received from another computing system.

An article of manufacture of the invention includes a computer-readable medium and means in the medium. The medium may be a recordable data storage medium, a modulated carrier signal, or another type of computer-readable medium. The means is for maintaining an email message store in which email messages are stored without organization. Each email message has an at least substantially unique identifier, and the email messages are indexed by this identifier. Metadata events regarding the email messages are stored as one or more partially ordered logs of updates to attributes of the email messages.

Embodiments of the invention provide for advantages over the prior art. In particular, the manner by which email messages and their metadata are stored by the invention is amenable to easy and robust synchronization among different copies, stores, or replicas of the messages and metadata. Because the email messages themselves are not organized for storage thereof, all of the email messages can be easily exchanged between different stores of email messages and compared to determine which copies should be added to a given store. Furthermore, the partially ordered nature of metadata events, as well as their at least substantially unique identifiers that do not have to depend on the identities of the stores, provide for relatively simple synchronization of metadata events. Should conflicts arise between two metadata events that cannot be resolved, the user may be asked to select which event takes precedence over the other event.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of the storage of email messages within a computing system, according to an embodiment of the invention, and is suggested for printing on the first page of the patent.

FIG. 2 is a diagram of metadata events regarding attribute changes to email messages, and how they are organized as partially ordered logs, according to an embodiment of the invention.

FIG. 3 is a diagram showing how email messages can be synchronized between two different copies, stores, or replicas of such messages, according to an embodiment of the invention.

FIG. 4 is a diagram showing how metadata events can be synchronized between two different copies, stores, or replicas of email messages, according to an embodiment of the invention.

FIG. 5 is a flowchart of a method for storing, updating, and synchronizing email messages, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

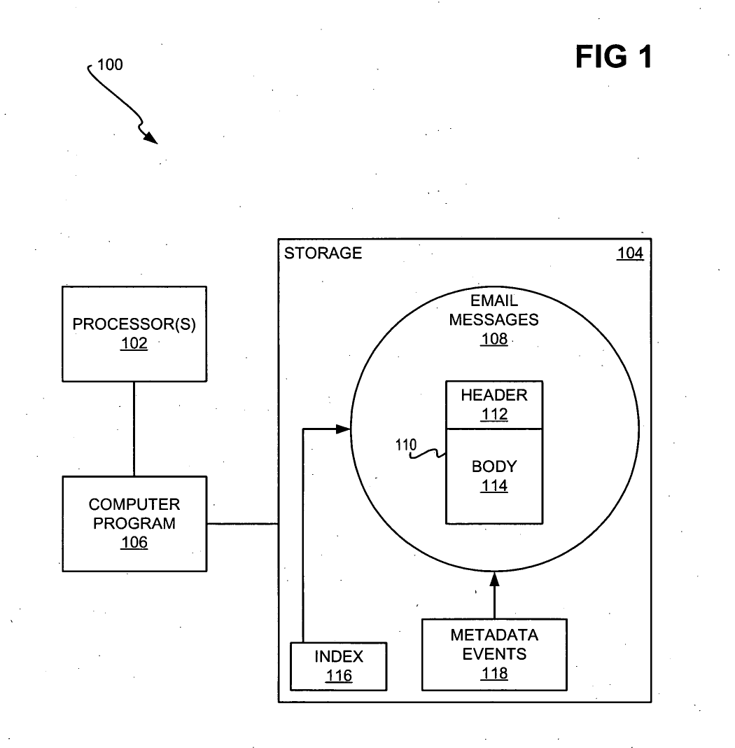

FIG. 1 shows a rudimentary computer system 100, according to an embodiment of the invention. The computer system 100 is depicted in FIG. 1 as including one or more processors 102, a storage 104, and a computer program 106. As can be appreciated by those of ordinary skill within the art, the computer system 100 may include other components, in addition to and/or in lieu of those depicted in FIG. 1, in other embodiments of the invention.

The storage 104 may be or include a non-volatile storage device, such as a hard disk drive, a volatile storage device, such as dynamic random-access memory (DRAM), as well as other types of storage devices. The storage 104 stores email messages 108, an index 116 of the email messages 108, and metadata events 118 regarding changes to attributes of the email messages 108. A representative email message 110 is depicted in FIG. 1, and includes a header 112 and a body 114. The header 112 typically includes routing information regarding the email message 110, such as the computer system that originated transmission of the message 110, and any computer systems or components that relayed the message 110 until its final delivery to the computer system 100. The header 112 may further include sender, recipient, and date and time information. The body 114 includes the actual text of the message itself, including any formatting information for this text, and any attachments to the text. It is noted that the division of the email messages as containing headers and bodies is for one embodiment of the invention only, and does not particularly limit all embodiments of the invention.

An email message is an electronic mail, which is generally and non-restrictively a text message and one or more optional file attachments communicated over a network. Users may be able to send email messages to a single recipient or broadcast them to multiple users. Email messages are sent to a simulated mailbox identified by an email address, where the simulated mailbox is in a network mail server computer system or a host or client computer system, until examined and deleted. An email computer program, also known as an email client, queries the mail server periodically to determine if new email messages have been received.

The email messages 108 do not have a purposeful organization as stored in the storage 104, and thus are said to be stored without organization. For instance, they are not stored in specific folders or directories, nor are they necessarily stored in the storage 104 by date received, by email sender, or by subject matter. Rather, the email messages 108 can be stored as an unorganized collection of files, with each file corresponding to one or more email messages. The email messages 108 may also be stored within one or more large files without any organization.

Each email message in 108 has an at least substantially unique label, whose uniqueness does not have to depend on having a unique identifier for the computer system 100, or the storage 104. The unique label is a collection of bits that can be used in conjunction with the indexing scheme to particularly identify and locate a given email message. An index 116 is generated that indexes the email messages 108 by the contents of the messages 108. In one, but not all embodiments, these unique labels may be derived solely from the contents of the messages, so that identical email messages will be guaranteed to have the same label. For example, the label may be a strong hash of the contents of the message. In one embodiment the label may be the entire contents of the message, including its header and body. The indexing scheme may be a cryptographically strong hash function, such as the SHA1 or MD5 hash functions. The indexing scheme may also employ a search tree, in lieu of a hash table. Therefore, duplicative email messages are easily located. In some embodiments of the invention, additional indices may be present, in addition to the index 116, so that performance of email retrieval, sorting, lookup, and other functions occurs relatively quickly, as can be appreciated by those of ordinary skill within the art, but such additional indices are not required by any embodiment of the invention.

The metadata events 118 each describe a change to an attribute of one of the email messages 108. The email messages 108 each have one or more attributes. For instance, these attributes may include whether an email message has been read and the priority of the email message. Furthermore, the email messages 108 are not actually deleted from the storage 104; it is noted that the email messages 108 not being actually deleted from the storage 104 is needed for embodiments of the invention to function properly with respect to synchronization. Therefore, when a user selects an email message for deletion, a deleted attribute is instead changed for that message so that it simply is no longer displayed to the user. In another embodiment, the user cannot actually select a message for deletion, but rather only indicate that a particular message is to be removed from a given folder.

Similarly, although the email messages 108 are not organized in folders or directories as stored in the storage 104, they may be organized in folders or directories for display purposes to the user. Therefore, a display purposes-only folder attribute or attributes for an email message may be set by the user, indicating that the message is to be displayed within a given folder, even though the email message itself has not moved as to the actual location in which it is stored within the storage 104. Further information regarding attributes and metadata events is provided later in the detailed description.

The computer program 106 is executed by the processors 102. The computer program 106 may be or may be part of an email client computer program, an operating system, or another type of computer program. The computer program 106 is to store and maintain the email messages 108 within the storage 104, generate and maintain the index 116 from the contents of the email messages 108, and/or generate and maintain the metadata events 118 regarding changes made to attributes of the messages 108. The computer program 106 is further to synchronize the messages 108 and the metadata events 118 with other messages and other metadata events that may be stored on a different computer system from the computer system 100. In particular, one approach to synchronization in accordance with an embodiment of the invention is provided in detail later in the detailed description.

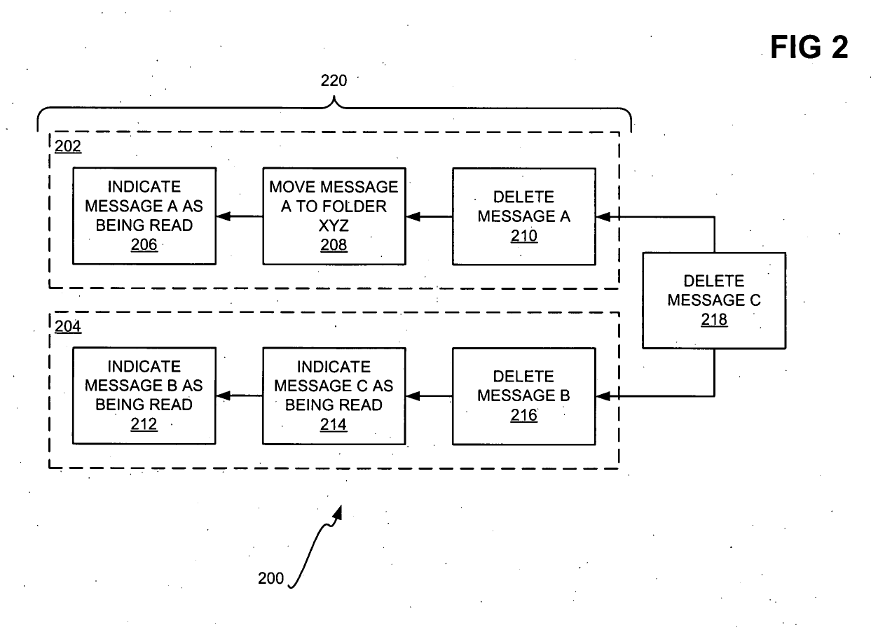

FIG. 2 shows partially ordered logs 200, 202, 204, and 220 of metadata events, according to an embodiment of the invention. FIG. 2 is described in relation to each of the four partially ordered logs 200, 202, 204, and 220. The partially ordered log 202 includes the metadata events 206, 208, and 210, and the partially ordered log 204 includes the metadata events 212, 214, and 216. The partially ordered log 220 includes the metadata events 206, 208, 210, 212, 214, and 216, but not the metadata event 218. The partially ordered log 200 includes all the metadata events 206, 208, 210, 212, 214, 216, and 218. It is noted that whether a partially ordered log is global as to all the email messages or local to a particular email message is not required by embodiments of the invention.

The partially ordered log 202 may be the manner by which the metadata events 206, 208, and 210 are stored in the storage 104 of a first computer system. The partially ordered log 204 may be the manner by which the metadata events 212, 214, and 216 are stored in a storage of a second computer system. If the email messages and the metadata events from the second computer system are synchronized with the email messages and metadata events of the first computer system, then the resulting partially ordered log is the partially ordered log 220. If the metadata event 218 is then generated at the first computer system, the partially ordered log 200 results.

As has been described, a metadata event describes a change to an attribute of an email message. This enables the email message to not have to be modified itself, nor moved or copied within an organization scheme on a storage like the storage 104. For example, the metadata event 206 indicates that email message A has been read. Thus, a has-been-read attribute of email message A may be set to true as represented by the event 206. The metadata event 208 indicates that email message A has been moved to folder XYZ. Thus, a display purposes-only folder attribute of email message A may be set to XYZ, to indicate that email message A should be displayed as within this folder, even though in actuality the message A has not been physically moved.

Furthermore, the event 210 indicates that email message A has been deleted, such that a deleted attribute of email message A may be set to true, to denote that the email message should not be displayed to the user any more, even though in actuality the message A has not been removed from the storage. Similarly, metadata events 212 and 214 indicate that messages B and C, respectively, have been read, such that corresponding attributes for this email messages may be set to true. Metadata events 216 and 218 indicate that messages B and C, respectively, have been deleted, such that corresponding attributes for them may also be set to true.

Each of the metadata events 206, 208, 210, 212, 214, 216, and 218 has an at least substantially unique identifier associated with it whose uniqueness is not dependent on having a unique identifier for the computer system that generated the event. The identifier of a metadata event is desirably unique as compared to the identifier of any other metadata event, but is at least substantially unique in that there is a low probability that two events will have the same unique identifier. The identifier does not have to be dependent on the computer system that generated the event, so that the identity of the computer system is not needed for synchronization and other purposes that utilize the identifiers of the metadata events.

The partially ordered log 202 is now considered in isolation, as if the only metadata events present within a given computer system are the metadata events 206, 208, and 210. That is, the metadata events 212, 214, and 216 may not have been received yet from another computer program, and the metadata event 218 may not yet have been generated. Of the partially ordered log 202, then, the event 206 is pointed to by the event 208, which is pointed to by the event 210. This means that the metadata event 206 was generated in time first, that the metadata event 208 was generated after the metadata event 206 was, and that the metadata event 210 was generated after the metadata events 206 and 208. Each event may thus be said to record one or more events which precede it, but not events which it precedes, since events cannot be altered once they are stored in the storage, and when an event is generated it is not possible to know what events might be recorded after it in the future.

With respect to the partially ordered log 202 in isolation, the metadata event 210 is a maximal metadata event, in that there is no event that has been generated after the event 210 has been generated—that is, there is no event that points to the event 210. The partially ordered log 202 is ordered because the order in which the events 206, 208, and 210 were generated in time is captured by and reflected within the log 202.

The partially ordered log 204 is now considered in isolation, as if the only metadata events present within a given computer system are the metadata events 212, 214, and 216. Of the partially ordered log 204, the event 212 is pointed to by the event 214, which is pointed to by the event 216. This means that the metadata event 212 was generated in time first, that the metadata event 214 was generated after the metadata event 212 was, and that the metadata event 216 was generated after the metadata events 212 and 214. With respect to the partially ordered log 204 in isolation, the metadata event 216 is a maximal metadata event, in that there is no event that has been generated after the event 216 has been generated.

The partially ordered log 220 is now considered in the context in which the metadata event 218 has not yet been generated. For instance, on a first computer system on which the metadata events 206, 208, and 210 have been generated, the metadata events 212, 214, and 216 generated on a second computer system may be received, such as during a synchronization process. Thus, the partially ordered log 220 includes all of the events 206, 208, 210, 212, 214, and 216. In this partially ordered log 220, there are two maximal events: the event 210 and the event 216. This is because it cannot be determined which of the events 210 and 216 was generated after the other event. That is, it cannot be determined which of the events 210 and 216 was generated last. Therefore, both of the events are considered maximal events, in that it cannot be said that any other metadata event was definitively generated after either event. The partially ordered log 220 is partially, but not totally, ordered because while the order among the events 206, 208, and 210 is captured by and reflected within the log 220, and the order among the events 212, 214, and 216 is captured by and reflected within the log 220, the order of the events 206, 208, and 210 relative to the events 212, 214, and 216, and vice-versa, is unknown.

Finally, the partially ordered log 200 is considered. The partially ordered log 200 starts with the partially ordered log 220, but adds the metadata event 218. For example, after a synchronization process occurred in which the metadata events 212, 214, and 216 were copied to the same computer system on which the metadata events 206, 208, and 210 were generated, the metadata event 218 may have been generated. Therefore, both events 210 and 216 now are pointed to by the event 218, because the event 218 was definitively generated after the events 210 and 216 were generated. Furthermore, the event 218 is the only maximal event within the log 200, since it was generated after all of the other events 206, 208, 210, 212, 214, and 216 were generated. The log 200 is partially, but not totally, ordered inherently because the order of the event 218 is known relative to all the other events, the order of the events 206, 208, and 210 is known, and the order of the events 212, 214, and 216 is known, but the order of the events 206, 208, and 210 relative to the order of the events 212, 214, and 216, and vice-versa, is unknown.

It is noted that there can be both partially ordered logs for each email message, as well as partially ordered logs of all the metadata events for all the email messages stored at a given computer system. For instance, the partially ordered log 202 may be considered a partially ordered log for the email message A. By comparison, the partially ordered logs 204, 220, and 200 that have been described can be considered partially ordered logs for all the email messages stored at a given computer system. The partially ordered logs 220 and 200, for instance, may be partially ordered logs for all the email messages stored at the first computer system at different points in time. The partially ordered log 204 may be a partially ordered log for all the email messages stored at the second computer system at a given point in time. Furthermore, however, it is noted that embodiments of the invention require partially ordered logs of metadata, such as partially ordered logs of metadata events as have been described. However, the partially ordered logs may be global logs, pertaining to all email messages, or may be on a per-email message basis, depending on how an embodiment of the invention is desired to be implemented, as can be appreciated by those of ordinary skill within the art.

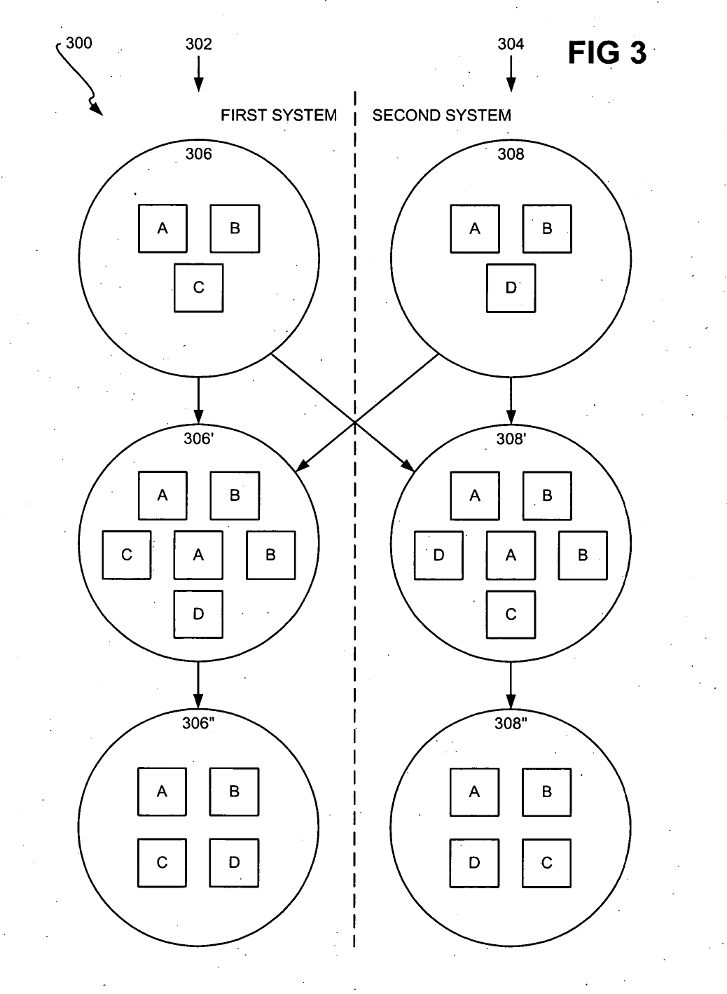

FIG. 3 shows how the email message storage scheme that has been described provides for straightforward synchronization between two different versions of email stores, with respect to the email messages themselves, according to an embodiment of the invention. In the situation 300, there is a first computer system 302 with a first email store 306, and a second computer system 304 with a second email store 308. The email stores 306 and 308 may also be referred to as replicas of the same collection of emails. In the embodiment depicted in FIG. 3, the first email store 306 includes email messages with unique labels A, B, and C, whereas the second email store 308 includes email messages with unique labels A, B, and D.

If different labeling schemes are employed to label the email messages, the labels may be different than as depicted in FIG. 3. That is, in FIG. 3, the email messages having the labels A and B in the store 306 are presumed identical to those having the same labels in the store 308, and the email message having the label C in the store 306 is presumed different than that having the label D in the store 308. In other embodiments of the invention, different schemes may result in the same message having different labels. In such embodiments, the synchronization process requires more verification that messages presumed different due to different labels are indeed different than is described herein, as can be appreciated by those of ordinary skill within the art.

First, the computer systems 302 and 304 send each other copies of their email messages. Therefore, the email store 306, now indicated as the email store 306′, includes email messages with labels A, B, and C, as it previously had, and also email messages with labels A, B, and D, from the email store 308. The email store 308, now indicated as the email store 308′, includes email messages with labels A, B, and D, as it previously had, and also email messages with labels A, B, and C, from the email store 306.

However, because each email message has a unique label, the first computer system 302 is able to easily recognize that the email messages with labels A and B received from the second computer system 304 are duplicates of the email messages that it already had with labels A and B. Therefore, in the resulting email store 306, indicated as the email store 306″, the first computer system 302 removes the duplicative copies of these email messages, such that the email messages with unique labels A, B, C, and D remain. Similarly, the second computer system 304 is able to easily recognize that the email messages with labels A and B received from the first computer system 302 are duplicates of the messages that it already had with labels A and B. Therefore, in the resulting email store 308, indicated as the email store 308″, the second computer system 304 removes the duplicative copies of these email messages, such that the email messages with unique labels A, B, C, and D remain.

Three aspects of the email message storage scheme that has been described in particular facilitate this straightforward email message synchronization approach. First, the email messages are not stored in any organized manner, such that attributes of the messages that may otherwise be considered to be part of the messages, including display purposes-only folder attributes and attributes indicating whether messages have been deleted, can be evaluated separately from the messages themselves during synchronization. Therefore, each of the computer systems 302 and 304 does not have to concern itself with the organization of its messages when comparing the email messages against those received from the other system, since there is no such organization.

Second, the email messages each have a unique label in one embodiment of the invention. Therefore, the email messages with the unique labels A and B in the email store 306 are guaranteed to be identical to the email messages with the unique labels A and B in the email store 308. Neither of the computer systems 302 and 304 has to conduct any sort of word-by-word analysis of any two email messages to determine whether they are identical, but rather only has to compare the unique labels of the messages. In one embodiment, the label is equal to the whole message's contents.

Third, the email messages are never deleted once they have been received within one of the stores 306 and 308. Because email messages that have been deleted by the user nevertheless remain in the email stores 306 and 308, each of the computer systems 302 and 304 does not have to concern itself with potentially receiving messages from the other system that it may already have deleted. Such deletions are taken into account when synchronizing metadata events, which will be described later in the detailed description. Thus, an email message is only deleted insofar as there is a deleted attribute or a removed-from-folder attribute, and the email message itself still exists. Such non-deletion of the messages provides for easier synchronization, because an email message cannot be deleted from one store, and then be reintroduced into that store when synchronization occurs with another store.

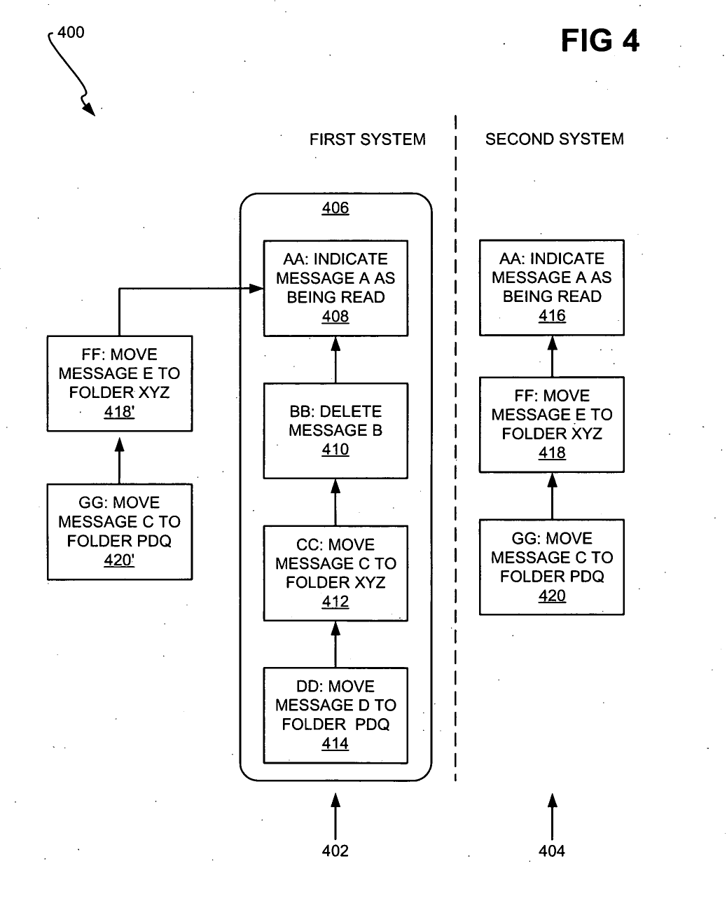

FIG. 4 shows how the email message storage scheme that has been described provides for synchronization between two different versions of email stores, with respect to the metadata events describing changes to attributes of the email messages, and thus with respect to the attributes themselves, according to an embodiment of the invention. In the situation 400, there is a first computer system 402 and a second computer system 404. The first computer system 402 originally has a global partially ordered log 406 of the metadata events 408, 410, 412, and 414. The second computer system 404 has a global partially ordered log of the metadata events 416, 418, and 420. Synchronization is described in particular relation to the first computer system 402 receiving metadata events from the second computer system 404, and not vice-versa, for illustrative clarity in FIG. 4. However, synchronization can and typically would be performed in both directions, from the first computer system 402 to the second computer system 404, as well as from the second computer system 404 to the first computer system 402.

The first computer system 402 originally has the metadata events 408, 410, 412, and 414 prior to synchronization. The metadata event 408 has the at least substantially unique identifier AA and denotes that the email message A should be indicated as having been read. The metadata event 410 has the identifier BB and indicates that the email message B should be indicated as having been deleted. The metadata event 412 has the identifier CC and indicates that the email message C has been moved for display purposes to the folder XYZ. The metadata event 414 has the identifier DD and indicates that the email message D has been moved for display purposes to the folder PDQ.

The second computer system 404 has the metadata events 416, 418, and 420. The metadata event 416 has the at least substantially unique identifier AA and denotes that the message A should be indicated as having been read. The metadata event 418 has the identifier FF and indicates that the email message E has been moved for display purposes to the folder XYZ. The metadata event 420 has the identifier GG and indicates that the email message C has been moved for display purposes to the folder PDQ.

The first computer system 402 begins receiving metadata events from the second computer system 404. Each metadata event that the second computer system 404 sends to the first computer system 402 is not preceded by any event that the second computer system 404 has not yet sent to the first computer system 402. Therefore, in the example of FIG. 4, the second computer system 404 sends the events 416, 418, and 420 to the first computer system 402 in that order: the event 416, followed by the event 418, followed by the event 420, since the event 418 occurs after the event 416 and the event 420 occurs after both of the events 416 and 418.

When the first computer system 402 receives the metadata event 416, which denotes that the email message A should be indicated as being read, the first computer system 402 notes that it already has an equivalent metadata event 408, because the events 408 and 416 have the same at least substantially unique identifier AA. Thus, the first computer system 402 ignores the event 416, since it is the same event as the event 408, and may have been received in a previous synchronization.

Next, the first computer system 402 receives the metadata event 418, to which the metadata event 416 links. The metadata event 418 indicates that the email message E has been moved to the folder XYZ. The first computer system 402 examines its metadata events for equivalent events. The system 402 does not have any such equivalent events because the event 418 has an at least substantially unique identifier, FF, that is different than any of the events of the system 402. The system 402 adds and processes the event 418, as the event 418′ indicated in FIG. 4. It is noted that the order in which the event 418′ was generated relative to the events 408, 410, 412, and 414 that the first computer system 402 already has can only be partially determined. That is, it is known that the event 418′ occurred after the event 408, since the event 408 has already been determined as being equivalent to the event 416 that is linked to the event 418 in the second computer system 404. However, the first computer system 402 will not be able to determine the order of the event 418′ relative to the events 410, 412, and 414. Therefore, the event 418′ is added off the event 408, such that the event 408 is linked to the event 418′ in addition to being linked to the event 410.

Finally, the first computer system receives the metadata event 420, to which the metadata event 418 is linked. The metadata event 420 indicates that the email message C has been moved to the folder PDQ. The first computer system 402 examines its metadata events for equivalent events. Because there are no such equivalent events—because the event 420 has the at least substantially unique identifier GG that is different than the other events of the system 402—the metadata event 420 is added and processed, as the event 420′ indicated in FIG. 4. This is because it is known, for instance, that the metadata event 420′ occurs after the metadata event 418′.

It is noted that events 412 and 420′ conflict. That is, the event 412 is indicating that the message C should be moved to the folder PDQ, whereas the event 420′ is indicating that the message C should be moved to the folder XYZ. A later event may resolve this conflict. However, if it does not, when the user views the folder PDQ or the folder XYZ, the first computer system 402 may request that the user resolve the conflict, asking the user whether the email message C should stay in the folder XYZ, as was previously done, when processing the event 412, or if the email message C should be moved to the folder PDQ, in accordance with the event 420′.

The synchronization scheme for metadata events described in relation to FIG. 4 thus leverages the separation of the email messages themselves from changes that are made to their attributes within the email message storage format of the invention. The partially ordered logs by which metadata events are stored allow for the metadata events to be synchronized such that conflicts between the changes to attributes of email messages between different metadata events are easily identified for user resolution without corrupting the email store.

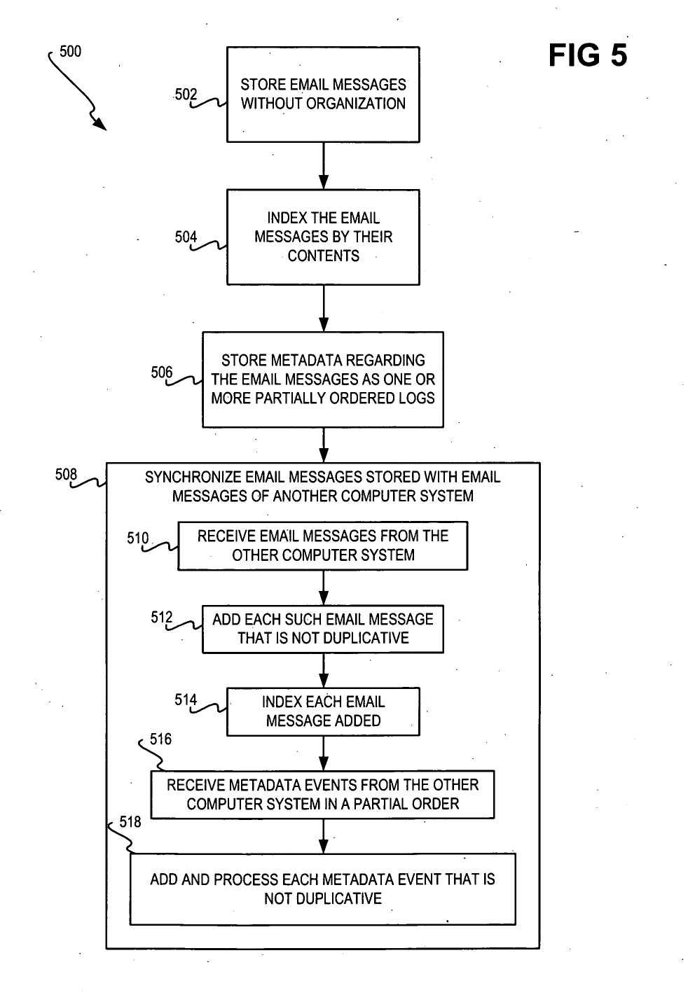

FIG. 5 shows a method 500 for storing and synchronizing email messages, according to an embodiment of the invention. The method 500 may be performed by a computer program of a computer system, such as the computer program 106 of the computer system 100. The method 500 is further consistent with the description of the email message storage format that has been described, as well as with the description of the email message synchronization processes that have been described.

Email messages are stored without organization (502). As has been described, this means that the email messages are stored without any purposeful organizational scheme. For instance, the email messages are not organized purposefully by the date in which they have been received, nor are they organized in user-specified folders. The email messages may be stored in individual files each corresponding to an email message, or one or more large files may store all of the email messages. Furthermore, in one computer system the messages may be stored as individual files, and in another computer system they may be stored as one or more large files. Each email message has an at least substantially unique label, such that the probability of two non-identical messages having the same label is very low. The methods described assume that no such collisions will occur.

The email messages are indexed in accordance with their contents (504). The content of an email message can include its body, its header, or both, in one embodiment of the invention, although this is not required of all embodiments of the invention. Indexing may include using a hash table or a search tree. Metadata is further stored regarding the email messages as one or more partially ordered logs of metadata events (506). There may be one or more global partially ordered logs, which describe all of the changes to the attributes of all of the email messages, or there may be one or more partially ordered logs per email message, each such log describing changes to attributes of just a single, corresponding email message. Each metadata event has an at least substantially unique identifier whose uniqueness does not depend on having a unique identifier for the computing system or device performing the method 500.

The email messages that have been stored may further be synchronized with the email messages of another computer system (508). Synchronization of such email messages may include performance of the processes that have been described in relation to FIGS. 3 and 4. First, the email messages are received from the other computer system (510). Each such email message that is not duplicative of an email message already stored is added (512). That is, each email message received that has a unique label that is different than the unique labels of already stored email messages is added. Any email message that has been so added is then indexed (514).

Next, metadata events are received from the other computer system in a partial order (516). That is, the metadata events that have not yet been received from the computer system will never precede the metadata events of the other computer system that have already been received from the other computer system during a given particular synchronization session. Received metadata events that are not duplicative with existing metadata events, based on their at least substantially unique identifiers, are added to the partially ordered logs of existing metadata events and processed against the email messages (518).

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. It is manifestly intended that this invention be limited only by the claims and equivalents thereof.

I claim:

1. A method comprising:
storing a plurality of email messages without organization, the email messages having one or more attributes;
indexing the email messages by contents thereof; and,
storing metadata regarding the email messages as one or more partially ordered logs of updates to the attributes of the email messages.

2. The method of claim 1, wherein the attributes for each email message comprise one or more folder attributes in which the email message is to be displayed.

3. The method of claim 1, wherein storing the email messages comprises storing the email messages as one of: a plurality of files, each file corresponding to one of the email messages; and, as a single file encompassing all of the email messages.

4. The method of claim 1, wherein indexing the email messages comprises employing one of a hash table and a search tree to index the email messages by the contents thereof.

5. The method of claim 1, wherein storing metadata regarding the email messages comprises storing one or more metadata events regarding each email message, each metadata event describing a change to one of the attributes of the email message.

6. The method of claim 5, wherein the metadata events regarding the email messages are stored in one or more partially ordered logs by email message.

7. The method of claim 5, wherein the metadata events regarding the email messages are stored globally in one or more partially ordered logs, without respect to any particular email message.

8. The method of claim 5, wherein each metadata event has an at least substantially unique identifier whose uniqueness does not depend on uniqueness of an identity of a computing device performing the method.

9. The method of claim 5, wherein each metadata event except for one or more maximal metadata events is linked thereto by one or more other metadata events in accordance with a partial order in which the metadata events are generated, the maximal metadata events not being linked thereto by any other metadata event.

10. The method of claim 1, further comprising synchronizing the email messages and the metadata regarding the email messages with a plurality of second email messages and second metadata regarding the second email messages.

11. The method of claim 10, wherein synchronizing the email messages with the second email messages comprises:
receiving each second email message;
adding each second email message that is not duplicated within the email messages to the email messages; and,
indexing each second email message that is not duplicated within the email messages and that has been added to the email messages.

12. The method of claim 11, wherein the metadata regarding the email messages comprises one or more metadata events regarding each email message and the second metadata regarding the second email messages comprises one or more second metadata events regarding each second email message, and
wherein synchronizing the metadata regarding the email messages with the second metadata regarding the second email messages comprises:
receiving each second metadata event in a partial order, such that any other second metadata event preceding the second metadata event in the partial order has already been received; and,
adding each second metadata event that is not duplicated within the first metadata events to the first metadata events.

13. A computing system comprising:
one or more processors;
a storage to store:
a plurality of email messages without organization, the email messages having one or more attributes including one or more display purposes-only folder attributes in which the email messages are to be displayed;
an index of the email messages by contents thereof, including at least one of bodies and headers of the email messages;
one or more metadata events regarding each email message, as one or more partially ordered logs of updates to the attributes of the email messages, each event describing a change to one of the attributes of a corresponding email message and having an at least substantially unique identifier without dependence on an identity of the computing system; and,
means for generating and maintaining the index of the email messages from the contents thereof and to synchronize the email messages and the metadata events with second email messages and second metadata events received from another computing system.

14. The computing system of claim 13, wherein each metadata event except for one or more maximal metadata events is linked thereto by one or more other metadata events in accordance with a partial order in which the metadata events are generated, the maximal metadata events not being linked thereto by any other metadata event.

15. The computing system of claim 13, wherein the means comprises one or more computer programs executed by the processors.

16. The computing system of claim 15, wherein the computer program is further to add to the email messages and index each second email message that is not duplicated within the email messages.

17. The computing system of claim 15, wherein the computer program is further to receive each second metadata event in a partial order, such that any other second metadata event preceding the second metadata event in the partial order has already been received, and to add each second metadata event that is not duplicated within the first metadata events to the first metadata events.

18. An article of manufacture comprising:
a computer-readable medium; and,
means in the medium for maintaining an email message store in which a plurality of email messages are stored without organization, the email messages are indexed by contents thereof, and one or more metadata events regarding the email messages are stored as one or more partially ordered logs of updates to attributes of the email messages.

19. The article of manufacture of claim 18, wherein the attributes comprise one or more display purposes-only folder attributes in which email messages are to be displayed, and each metadata event has an at least substantially unique identifier without dependence on an identity of a computing device implementing the means.

20. The article of manufacture of claim 18, wherein the computer-readable medium is one of a recordable data storage medium and a modulated carrier signal.
